(19) United States
(12) Patent Application Publication
(10) Pub. No.: US 2004/0059633 A1
(43) Pub. Date: Mar. 25, 2004

(54) Dining system

(76) Inventors: Andrew Rankin, Falls Church, VA (US); Brian Williams, Arlington, VA (US); Kenneth W. Schwenke, Bryn Mawr, PA (US)

Correspondence Address: Eugene E. Renz, Jr., P.C., 205 North Monroe Street, Post Office Box 2056, Media, PA, 19063-9056, US

(21) Appl. No.: 10/621,735

(22) Filed: Jul. 17, 2003

Related U.S. Application Data
(60) Provisional application No. 60/396,663, filed on Jul. 18, 2002.

(51) Int. Cl. G06F 17/60

(52) U.S. Cl. 705/15

(57) ABSTRACT

An improved dining system that enables students in the vicinity of a campus to dine at a variety of dining establishments located on- or off-campus, using account reconciliation to transfer funds to the dining establishments based upon use. Students and their parents have 24 hour web access to their accounts, which may be reviewed for accuracy and to make sure the account is appropriately used. Through the web interface, funds may be added to the accounts, and even may be pre-authorized for automatic replenishment depending upon pre-established account parameters. Unused funds may be refunded from the account upon demand. The accounts may be set up so that parents have supervisory control over their account, that is, so that they may control the disbursement of funds and/or limit which dining establishments are available to the student. The overall dining system is easily administered by an authorized administrator through a secure administration web interface.

This application claims the benefit under 35 USC 119(e) of U.S. Provisional Application No. 60/396,663, filed Jul. 18, 2002, entitled “CAMPUS DINING NETWORK”, incorporated herein by reference.

### BACKGROUND OF THE INVENTION

The present invention relates in general to restaurant systems and in particular to student dining systems that comprise plural restaurants and dining establishments located at diverse locations off- or on-campus in a greater campus area.

The traditional campus dining systems consist of two major types of operations, the more-common “board plan” and a growing “point-based” system. Students who enroll for a traditional board plan purchase the right to eat up to a certain number of meals per week, with a complete board-plan considered generally to be 19 (3 per weekday, 2 per weekend day) meals or 21 meals. Students who fail to eat all their contracted meals traditionally do not receive any return compensation, and in fact traditional board plans anticipate a “missed meal factor” (percentage of meals paid for but not eaten) of approximately 40%, thereby increasing their profit. Also, student's tastes have been changing, so that they tend to eat at unusual meal times and desire “branded” restaurants (eg. Subway™, Burger King™, Pizza Hut™, etc.). As a result, some universities have, over the last decade, augmented the traditional board plan with point-based plans. In the point-based plans, students get “points” that they can use at on-campus branded restaurants and, oftentimes, at on-campus convenience stores.

In any of the above plans, the student is provided with an identification card which indicates his or her eligibility to eat a given meal. In the “point” system, the students ID card is often a “debit card”, credited with a certain number of points that can be used for on-campus dining purchases. On each use, the debit card is accessed by a point of sale terminal (POS), thereby causing a debit transaction from their account. When their account is reduced near zero, the student provides additional funds to credit his or her account. In some systems, the debit card includes the account balance stored therein, and the debiting takes place right in the card, such as taught in U.S. Pat. No. 5,969,316 to Greer et al. In other systems, the account balance is maintained by a central facility, as taught for example in U.S. Published application 2002/0095380 to Singhal, and each transaction is accomplished by means of a communication linkup to the central facility. In the traditional board plans or point-based systems, any value these accounts have expire at the end of a given semester or year, and no refund is offered to the student.

Other systems considered generally relevant to the present invention are described in U.S. Published application 20030065559 to Vonder Haar, teaching a restaurant system using a virtual private network carried out over the Internet, and U.S. Pat. No. 5,649,118 to Carlisle et al, teaching a smart card system associated with food purchases. All of the above patent applications and publications are included herein by reference.

While such systems provide a facile means for students to obtain food services, the systems are associated with several inconveniences that are addressed by the present invention. First and foremost, the traditional board plans profit by students not eating meals they have paid for, thereby encouraging food-service operations to be less than totally attractive to students so that the plans can make more money. Second, even in the more-progressive point-based systems, any unspent money—or points—on the card generally is forfeited at the end of a given semester or year. Third, purchases on the university's card system are generally restricted only to on-campus choices, with restaurant choice, hours, and service-levels determined by the university and/or its food-service provider. If the student wishes to use a commercial facility located off-campus in the greater-campus area, they must use other forms of payment (e.g. cash). Fourth, the traditional systems often involve clumsy methods to add funds to the account, requiring travel to a particular office on the campus (e.g. the accounting, bursars, or food-service office) and do not allow parents easy monitoring or supervisory control of the account. And, last, these systems have operated without any competition of any kind targeted at providing a better meal-plan option for today's students and their parents.

### SUMMARY OF THE INVENTION

The present invention overcomes these and other inconveniences of the prior systems through an improved dining system that enables students to easily use their account at a variety of dining establishments located at selected locations on- or off-campus in a greater-campus area. Because of account reconciliation, the present invention does not restrict which dining establishments in the greater campus area may take part in the system. In addition, students and their parents or other guardians have 24 hour web access to their accounts, which may be reviewed for accuracy and to make sure the account is appropriately used. Funds may be easily added to the accounts through the web interface, and even may be pre-authorized to add funds automatically depending upon pre-established parameters. Unused funds may also be refunded from the account. The accounts may be set up so that guardians have supervisory control over the account, that is, so that they may control the disbursement of funds and/or limit which dining establishments are available to the student. The overall dining system is easily administered by an authorized administrator through a secure administration web interface. These and other features of the present invention will be described in more detail below and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows the overall dining system of the preferred embodiment of the invention.

FIG. 2 shows a detailed view of the dining system in the preferred embodiment of the present invention.

FIG. 3 shows a detailed view of the Processing Center in a preferred embodiment of the present invention.

FIG. 4A comprising FIGS. 4A′ and 4A″ show a site map for the Admin Interface of the AWS.

FIG. 4B shows a wire frame diagram of the Admin interface of the AWS.

FIG. 5 shows a sample transaction receipt.

FIG. 6A comprising FIGS. 6A′ and 6A″ show a site map for a market site.

FIGS. 6B and 6C show wire frame diagrams of webpages in the Market site.

FIG. 7 comprising FIGS. 7A and 7B show the object model for the preferred embodiment.

### DETAILED DESCRIPTION OF THE PREFERRED EMBODIMENTS

The present invention will now be described in detail with reference to the preferred embodiment as illustrated in the accompanying drawings. While numerous specific details are set forth in order to provide a thorough understanding of the present invention, it should be clear to those skilled in the art that not all of the details are required for the invention to work, and that other variations may be possible which also are within the scope of the present invention. Also, some well known procedures or equipment have been omitted from this description in order to not unnecessarily obscure the present invention.

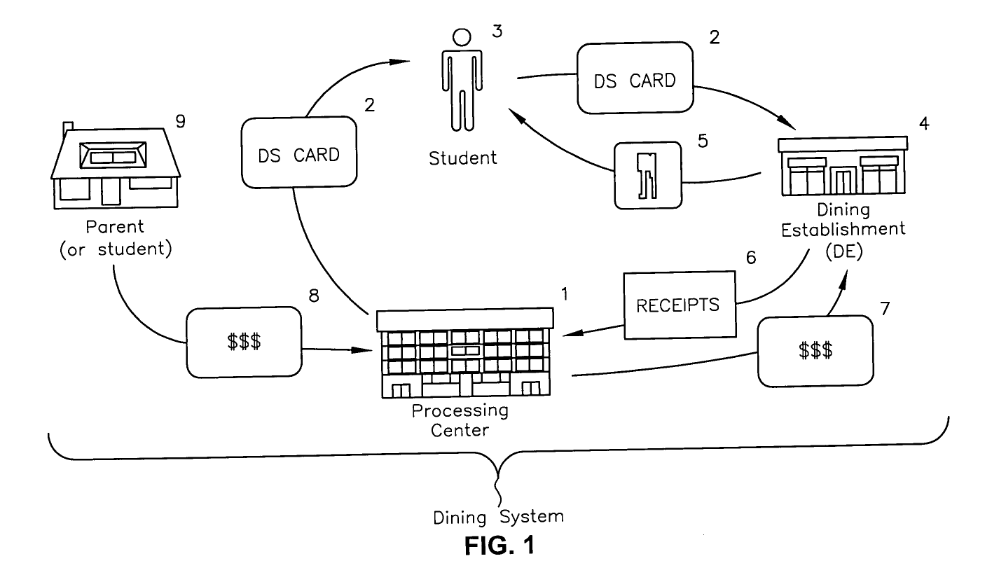

In accordance with the preferred embodiment of the present invention, as broadly shown in FIG. 1, Dining System (DS) Processing Center (PRC) 1 issues an identification card (DS Card) 2 to student 3, who visits dining establishment (DE) 4 and receives food services 5 while presenting DS Card 2. Dining Establishment (DE) 4 communicates 6 with PRC 1 in order to post the dining transaction and cause the student's account to be debited and the DE's account to be credited. Money 8 is added to the student's account by parent (or student) 9 when needed, and periodically, PRC 1 issues payment to DE 4 for the services rendered to the students.

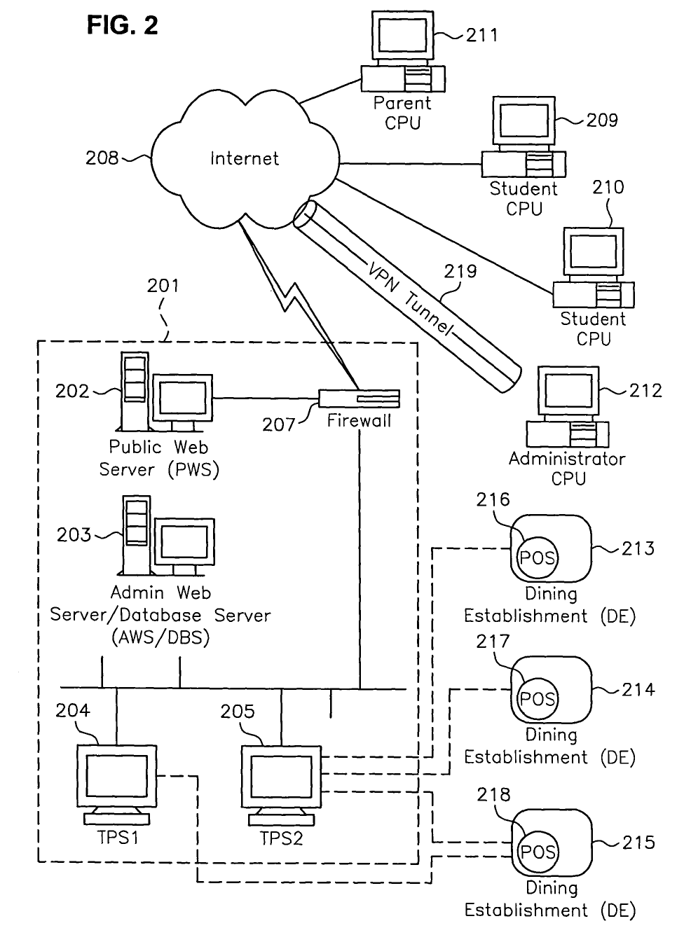

In further detail, as shown in FIG. 2, the Dining System (DS) in the preferred embodiment comprises Processing Center (PRC) 201, which is connected through Firewall 207 to Public Web Server (PWS) 202 and the Internet 208. Public web server (PWS) 202 is used by students and parents to access their accounts via the web. For example, this machine may be a moderately powered, Intel-based system running FreeBSD, Apache, and/or PHP.

Processing Center (PRC) 201, which will be described in more detail below, comprises Admin Web Server/Database Server (AWS/DBS) 203 (which may comprise separate processors for these two functions), and a plurality of Transaction Processing Servers (TPS) 204, 205; all linked by Local Area Network. The TPS servers can be somewhat lower-end, Intel-based machines, since the actual load on these machines, even during peak times, is not expected to be very high. The TPS servers are able to function independently, so if one were to fail, the other could handle the task of authenticating all the requests from the dining establishments, as described in more detail below. Each of these machines runs two instances of an SQL database server. One instance contains all of the transactions authorized by that system. The other contains a partial replica of the tables in the main web database. These tables have the necessary information for each TPS server to authorize transactions. Maintaining a local copy of this data on each server ensures that the TPS servers are able to authorize and record transactions even if the main web database is down.

In order to ensure data consistency across all of the database instances, a replication package is implemented. This package uses a “store and forward” asynchronous replication method configured to run at predefined intervals. These intervals are selected to minimize latency and maximize performance. To prevent data corruption, the package supports highly-configurable conflict resolution algorithms to ensure that the correct data is retained. Three different replication loops are required. The first loop replicates a subset of tables from the main web database to each of the TPS servers. The PRC servers each reference their local copy of this data when processing authorizations. Thus, if the main web database becomes unavailable, the TPS servers can continue to function.

The remaining two loops replicate data between the transaction databases on each of the two TPS servers and the two separate transaction databases on the Admin/Database server. The purpose of maintaining these separate databases and replication loops is to ensure that if one TPS server goes down, the other is still able to replicate its transactions back to the main PRC system.

PRC 201 and Public Web Server (PWS) 202 communicate remotely through the internet with a plurality of computer interfaces, such as student computers 209, 210, parent computer 211 and administrator computer 212. Any of these remote computers may use a secure link, such as VPN tunnel 219. Processing Center 201 also communicates with a plurality of point-of-sale terminals (POS) 216, 217, 218 located at various Dining Establishments (DEs) 213, 214, 215.

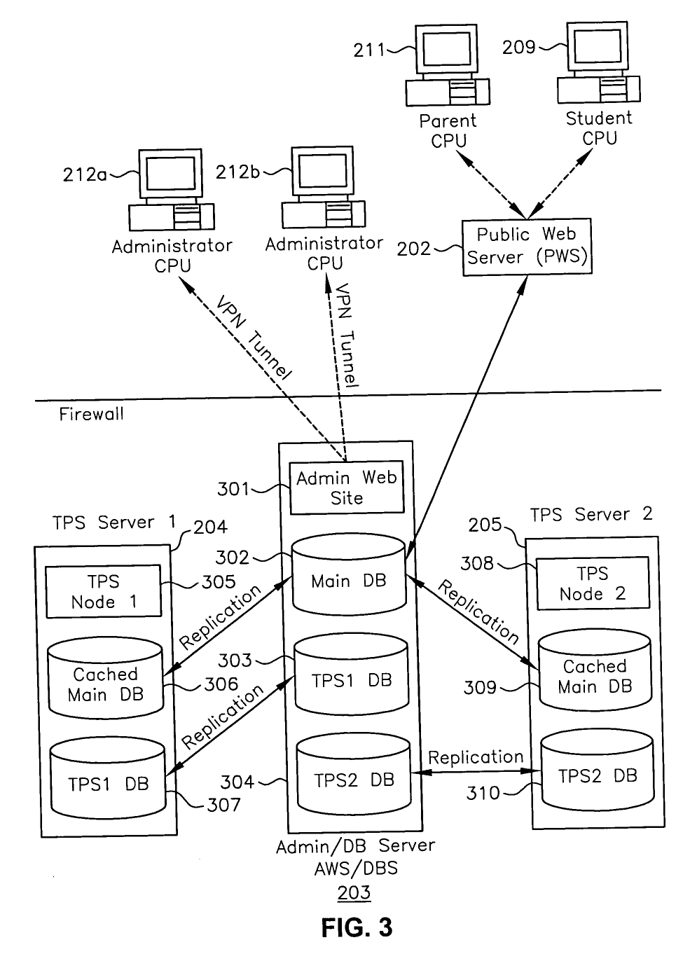

FIG. 3 shows Processing Center (PRC) 201 in more detail. Admin Web Server/Database Server (AWS/DBS) 203 contains the Admin Web Site 301 which maintains the web interface for administrators 212a, 212b to administer the dining system. AWS/DBS 203 also contains Main DB 302 holding account information for all of the dining customers and dining establishments, and transaction processing server databases 303 and 304. Each Transaction Processing Server (TPS) 204, 205 contains TPS Node 305, 308, respectively, and Cached Main DB 306, 309 which is a cached copy of Main DB 302, and transaction processing server databases 307, 310 which are replicated copies of transaction processing server databases 303, 304, respectively.

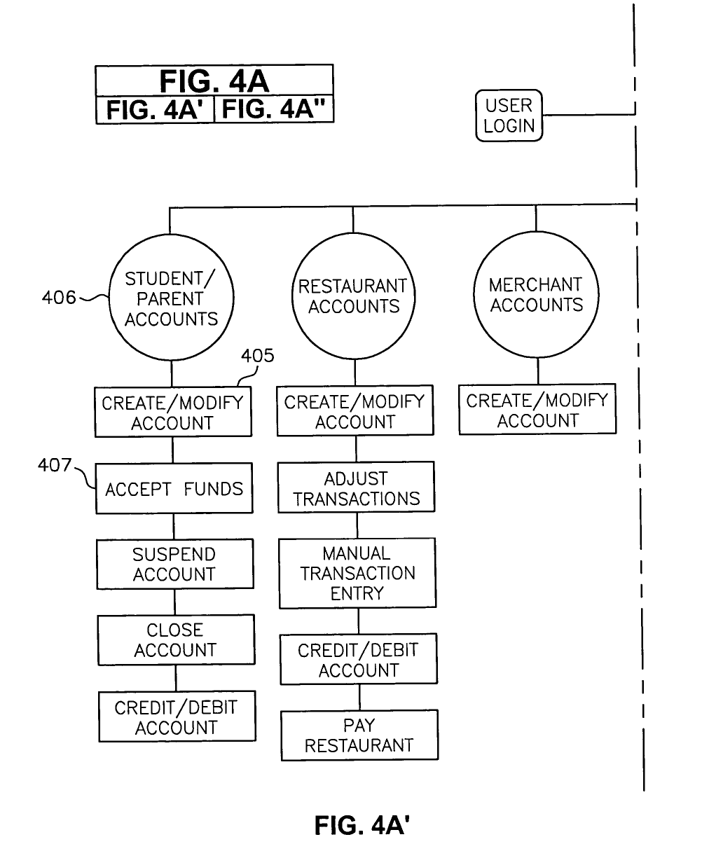

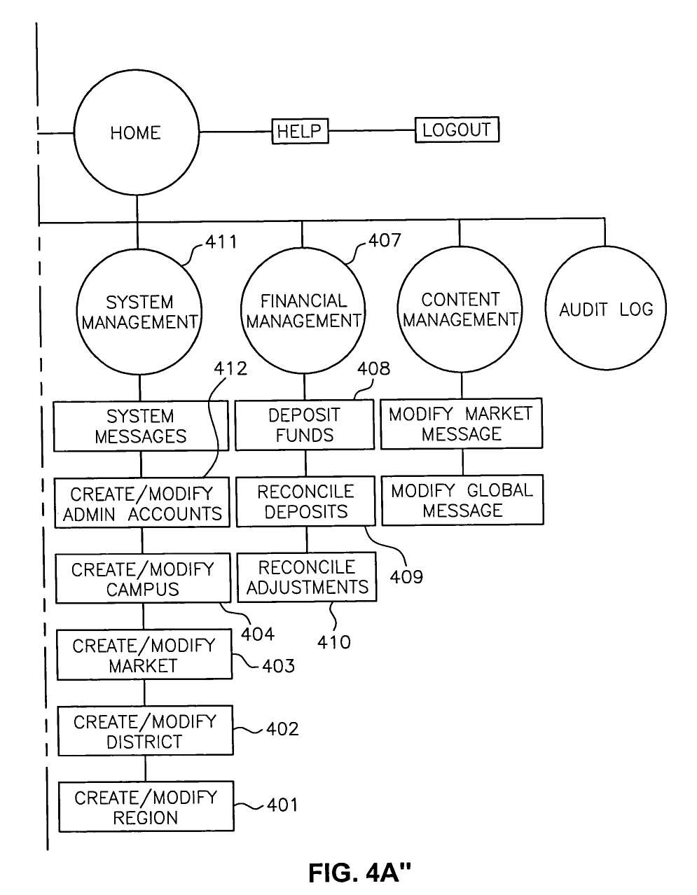

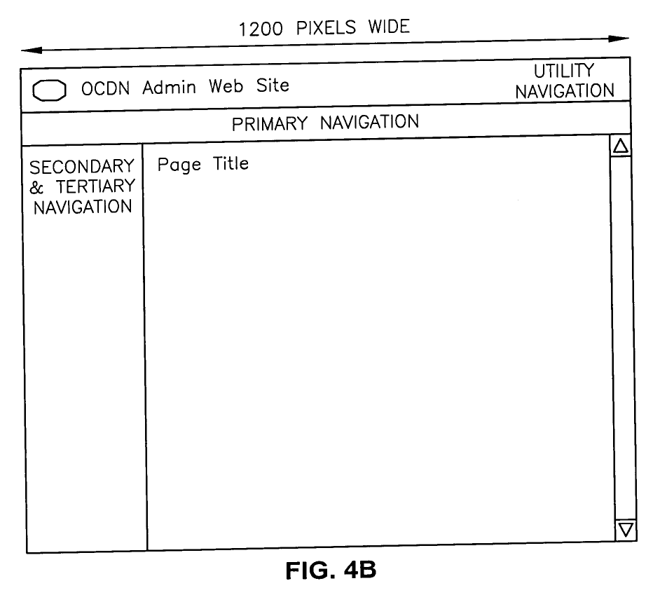

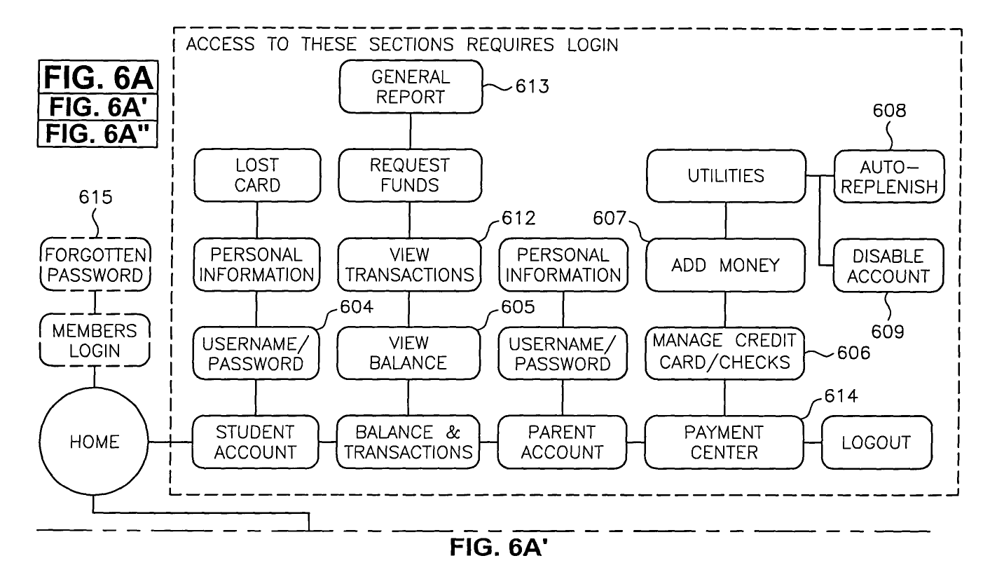

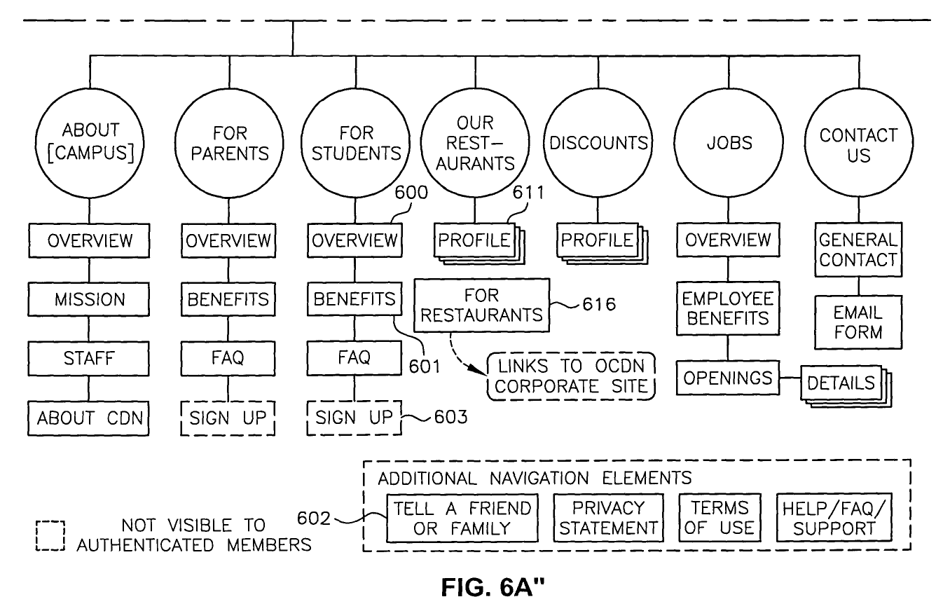

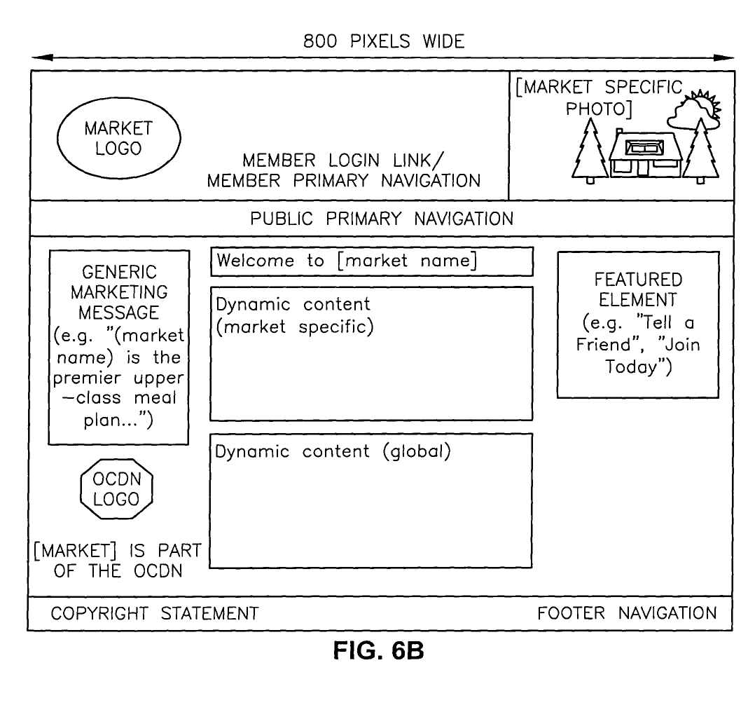

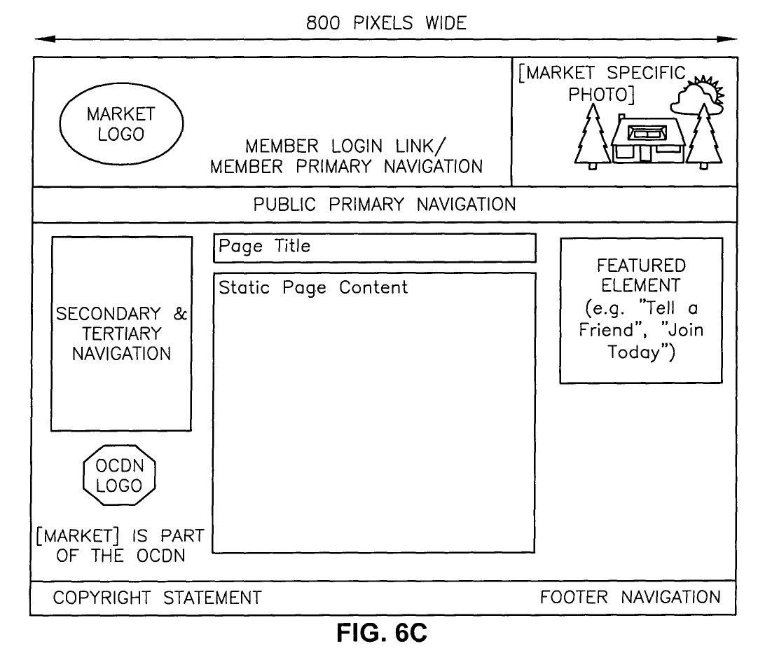

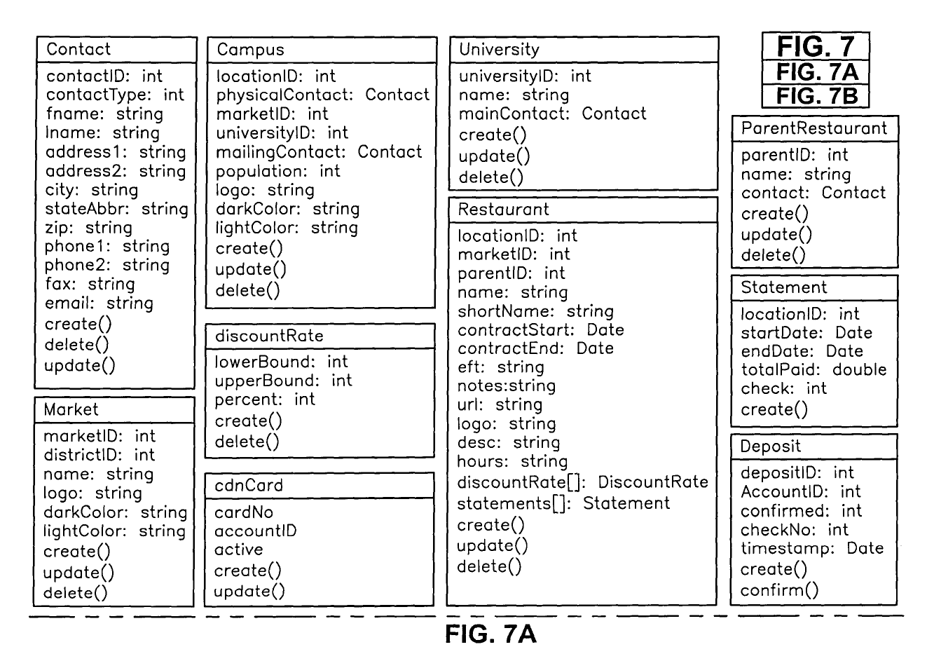

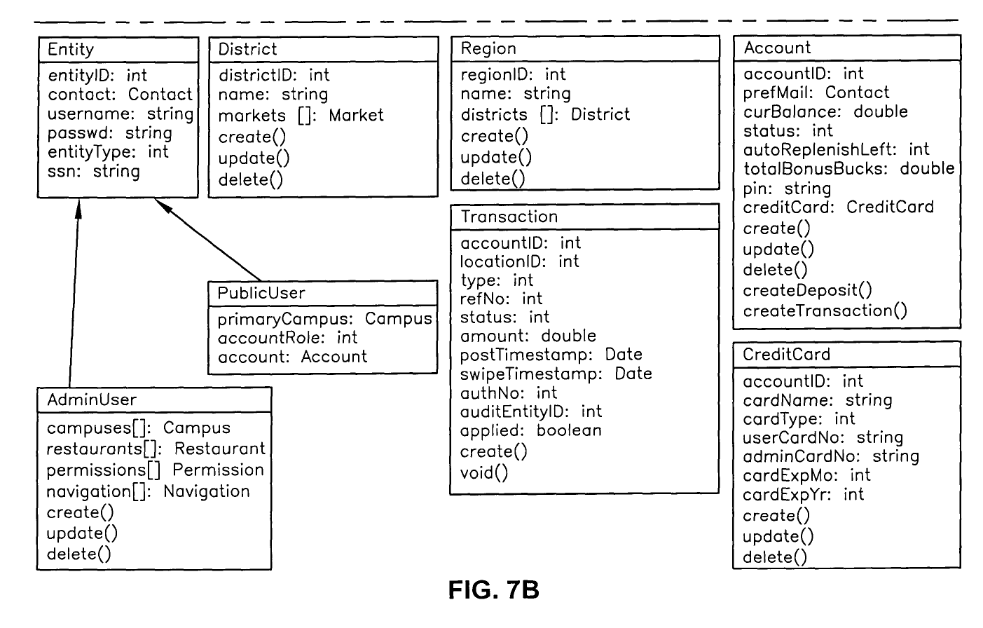

The operation of the present invention in the preferred embodiment may be seen in conjunction with FIGS. 1-3, the websites shown in FIGS. 4A (4A′ and 4A″), 4B, and FIGS. 6A (6A′ and 6A″), 6B, 6C, the Program Classes included in the appendix attached hereto, and the Object Model of FIGS. 7 (7A and 7B).

Initially Administrators 212, through AWS 203, create customer (student) accounts, vendor accounts for each of the DEs, and groupings such as: market, district, and region. A typical sequence of administrator actions is as shown in FIGS. 4A′ and 4A″ and as follows:

Admin Creates a New Region.

1. Admin logs into the AWS.

2. Admin navigates to the System Management section.

3. Admin clicks “Create Region.” (401)

4. Admin enters region information.

5. Admin clicks “Done” to save new region information.

Admin Creates a New District.

1. Admin logs into the AWS.

2. Admin navigates to the System Management section.

3. Admin clicks “Create District.” (402)

4. Admin enters district information.

5. Admin clicks “Done” to save new market information.

Admin Creates a New Market.

1. Admin logs into the AWS.

2. Admin navigates to the System Management section.

3. Admin clicks “Create Market.” (403)

4. Admin enters market information.

5. Admin clicks “Done” to save new market information.

Admin Creates a New Campus.

1. Admin logs into the AWS.

2. Admin navigates to the System Management section.

3. Admin clicks “Create Campus.” (404)

4. Admin enters campus information.

5. Admin clicks “Done” to save new campus information.

Admin Enters a New Restaurant into the System.

1. Admin logs in to the AWS.

2. Admin navigates to the Restaurant Accounts section.

3. Admin clicks “Create” to create a new restaurant record. (405)

4. Admin enters restaurant name, contact info, hours, payment information, etc.

Administrators apply deposits to customer accounts, apply credits and fees, and manage customer account information. Typical sequences of these events is presented as follows:

Admin Accepts Funds for a Student Account.

1. Admin logs into the AWS.

2. Admin navigates to the Student/Parent Accounts section. (406)

3. Admin selects an account by one of the following parameters: student name, account number, or card number.

4. Admin clicks “Accept Funds.” (407)

5. Admin selects the fund type: cash, check, or credit card.

For Cash

1. Admin enters cash amount.

2. Admin clicks “Done, Print Receipt” and prints a receipt.

3. Admin stores the cash in a secure location pending deposit to the bank.

For Check

1. Admin enters check amount.

2. Admin enters check number.

3. Admin clicks “Done, Print Receipt” and prints a receipt.

4. Admin stores the check in a secure location pending deposit to the bank.

For Credit Card

1. Admin enters credit card number, expiration date, and name on the card.

2. Admin clicks “Process” and waits for the online credit card transaction to process.

3. If the transaction fails, admin clicks “Cancel” and does not apply funds to the account.

4. If the transaction succeeds, admin clicks “Done, Print Receipt” and prints a receipt.

Campus Admin Makes a Deposit of Student Funds.

1. Admin logs into the AWS.

2. Admin navigates to the Financial Management section. (407)

3. Admin selects market.

4. Admin clicks “Deposit Funds” (408) which generates a Deposit Report. The Deposit Report lists all deposits at the selected market since the last deposit.

5. Admin confirms that all the deposits on the report are physically available for deposit to the bank. Any deposits not available are removed from the Deposit Report and are dealt with later.

6. When the Deposit Report matches the deposits available, the admin clicks “Done” and prints the deposit report.

7. Admin deposits funds at local bank.

Accounting Admin Reconciles Dep Sits.

1. Admin logs into the AWS.

2. Admin navigates to the Financial Management section. (407)

3. Admin monitors the deposits as reported by the DS bank.

4. Admin matches the bank deposit with a Deposit Report in the WS. (409)

5. If the deposits match, admin marks the Deposit Report as “cleared.”

6. If the deposits don't match, admin makes manual corrections before marking the Deposit Report as “cleared.”

Accounting Admin Reconciles Credits and Debits.

1. Admin logs into the AWS.

2. Admin navigates to the Financial Management section.

3. Admin clicks on Reconcile Adjustments. (410)

4. An Adjustment Report is generated. This report contains all uncleared adjustments since the last report. The adjustment report will total up all credits and debits.

5. Admin uses this information to update the external DS accounting system.

6. Once the accounting system is updated, the Admin clicks “Cleared” and the adjustments contained in the report are marked cleared.

Administrators with appropriate access can also manage other administrator accounts through AWS 203.

Admin Creates a New Administrator Account.

1. Admin logs into the AWS.

2. Admin navigates to the System Management section. (411)

3. Admin clicks “New Admin Account.” (412)

4. Admin enters admin user information.

5. Admin assigns permissions to the new admin account.

6. Admin clicks “Done” to save the new admin account.

After the initial accounts for the students and merchants are set up, the DS is ready for normal operation. At regular intervals or as needed, AWS/DB 203 updates the TPS databases 303 and 304, which are then replicated into 307 and 310 to ensure that they have current student and merchant balance information.

When student 3 wishes to use a dining establishment, such as DE 213, student 3 presents identification card 2, and corresponding POS terminal 216 dials a toll-free number which connects it to one of the TPS servers, say 204. The initial connection provides authorization for the transaction by checking the available balance for the customer's account as stored in Cached Main DB 306, or by communication with Main DB 302. Any subsequent transaction information is sent by POS 216 to TPS 204 and stored in TPS database 303.

A typical sequence of steps performed by the student and the merchant at the DE are as follows:

Student Makes a Purchase at a Restaurant.

1. Student gives merchant their DS card.

2. Merchant presses the single-card purchase button on the POS terminal.

3. Merchant swipes card through POS terminal.

4. POS terminal dials the TPS server.

5. Merchant enters the transaction amount.

6. TPS server makes an entry in the transactions database which contains: student card number, merchant ID number, transaction amount, and date/time.

7. TPS server compares the purchase amount to the student's account balance.

8. TPS server returns a positive response if the account balance is greater than or equal to the transaction amount and a negative response if the account balance is less than the transaction amount.

9. POS terminal prints a receipt which indicates if the transaction passed or failed.

10. Student fills in a tip amount and signs the receipt.

11. Student keeps one copy of the receipt, and returns the other copy to the merchant.

Student Makes a Purchase Without the Card (in Person or Over the Phone).

1. Student tells the merchant their card number and PIN (last four digits of their SSN).

2. Merchant presses the single-card purchase button.

3. Merchant keys in the student's card number.

4. POS terminal dials the TPS server.

5. Merchant keys in the student's PIN.

6. Merchant enters the transaction amount.

7. TPS server compares PIN entered with the student PIN from the database and rejects the authorization if the PIN does not match.

8. TPS makes an entry in the transactions database which contains: student card number, merchant ID number, transaction amount, and date/time.

9. TPS server compares the purchase amount to the student's account balance.

10. TPS server returns a positive response if the account balance is greater than or equal to the transaction amount and a negative response if the account balance is less than the transaction amount.

11. POS terminal prints a receipt which indicates if the transaction passed or failed.

12. Student fills in a tip amount and signs the receipt.

13. Student keeps one copy of the receipt, and returns the other copy to the merchant.

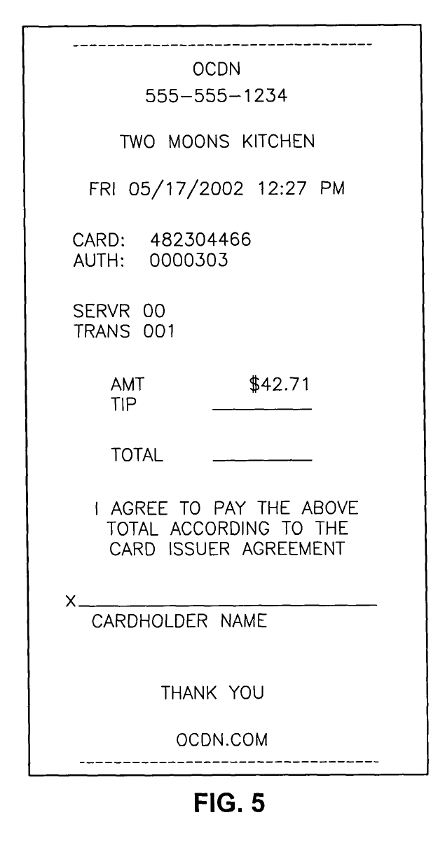

A typical paper receipt for the transaction is shown in FIG. 5. On a nightly basis, vendors may modify the transaction amounts to take tips into account. Once those modifications have been made, the transactions from a given POS terminal are uploaded to a TPS server in a batch upload.

Merchant Finalizes Transactions by Including Tip Amounts.

1. Merchant presses the batch upload button on the POS terminal.

2. POS terminal dials the TPS server.

3. Merchant steps through the transactions stored in the POS terminal and compares to the paper receipts for the day.

4. The tip amount, if any, from the paper receipt is entered into the POS terminal.

5. TPS server makes an entry in the transaction database for each transaction. This entry contains: card number, transaction amount, and date/time.

6. When finished, the POS terminal deletes all transactions stored in the terminal.

Also on a regular schedule, AWS/DB 203 pulls transaction data from the TPS 204, 205. Once transactions reach AWS/DB, they are applied to customer account balances in Main DB 302 and replicated to the TPS cached main DBs 306, 309.

AWS/DB 203 also provides the information necessary to properly track cash flow and account balance information in an external accounting system. This interface allows administrators to transfer information to external accounting systems for further analysis.

Public Web Server 202 (PWS) provides an interface for the public to view information about the DS, such as a list of participating dining establishments and their associated characteristics, other sales and promotional information about DS, and information on how to enroll in the program; as shown generally in FIGS. 6A′, 6A″, 6B and 6C, and described in the following sequence of actions:

New Student Visits the DS Web Site to Find Information About the Meal Plan.

1. Student goes to www.ocdn.com.

2. Student clicks on “Is DS on your campus?” link.

3. Student clicks on their State on a map of the USA, or selects their State from a pull-down list. (600)

4. Student then views a list of schools in the selected state which have a DS meal plan.

5. If their school is on the list, they click on the school and are taken to the home page for the market.

6. Student clicks on the “Information for Students” link and is taken to a page which describes the benefits of the DS meal plan. (601)

New Student Sends a Message to Their Parents Encouraging the Use of the Meal Plan.

1. From their market web site, the student clicks on the “Tell a Friend” link. (602)

2. Student can then enter information about their parents (minimum of name and email address—could include mailing information).

3. The student will be presented with a standard email message which they can customize and send to their parents.

New Student Signs Up Online.

1. Student clicks on “sign up” link from market home page. (603)

2. Student fills out contact information.

3. Student enters billing information or fills in parent information and triggers email message.

New Student Chooses to Sign Up and Invoice Parent for the Cost of the Plan:

1. Student logs in through the PWS.

2. Student goes through normal sign up procedure, indicating contact information and parent's name and address.

3. Student chooses meal plan amount and chooses, as payment option, that they would like to invoice parent.

4. Account is created as “Pending” and invoice is sent to parent.

5. Parent pays invoice.

6. Card is sent to student.

New Student Signs Up Via Mail.

1. Student fills out sign up form with contact information and billing information.

2. Student sends sign up form and check to DS HQ.

The customer can also enroll in person or by telephone:

New Student Signs Up in Pers n.

1. Student goes to campus office and fills out sign up form with contact information and billing information.

2. Student gives form and check or cash to campus admin.

New Student Signs Up Via Phone.

1. Student calls DS HQ and provides contact and billing information over the phone.

2. Student funds the account with a credit card or mails in a check later.

Public Web Server 202 (PWS) also provides an interface for students and their parents or guardians to check account and transaction information and to add funds to their account and/or request refunds. In a preferred embodiment of the present invention, the accounts may be set up so that distinct student and parent interfaces are provided, with the parent interface empowered with supervisory control not available to the student. For example, the parent may be able to control the manner and rate at which funds are disbursed from the account. The parent may also be able to limit which dining establishments are available to the student and at what time of the day. Thus, in the following operational examples, some of the functions listed below may be available only to the parent if the parent has invoked supervisory control:

Student/Parent Checks Balance Via Web Site.

1. Student/Parent goes to market site.

2. Student/Parent logs in with username and password. (604)

3. Current balance is available on the first page the student/parent sees after logging in. (605)

4. If the balance is below $25, a pop-up message is displayed asking the student/parent if he/she would like to add funds to the account.

Student/Parent Adds Funds Via Web Site.

1. Student/Parent logs in through the market site.

2. Student/Parent navigates to the Account section.

3. If a credit card or checking account is stored, then the Student/Parent fills in the amount of funds they would like to add, enters their password, and clicks Add. (606)

4. Otherwise, the Student/Parent enters credit card or checking account info, the amount of funds they would like to add, and clicks Add. (607)

Student/Parent Authorizes Automatic Fund Replenishment from the ‘Members’ Area:

1. Student/Parent logs into the ‘members-only’ portion of the DS web site.

2. If the current student/parent is the bill payer for the account, the student/parent clicks on the ‘Payment Center’ link (614) and then ‘Set Auto-Replenish.’ (608)

3. Student/Parent clicks the ‘Turn On’ button to enable the auto-replenish feature.

4. If necessary, the Student/Parent may enter custom values for either the number of times to run auto-replenish or how much to add whenever the service runs.

5. If Student/Parent provides custom values, the Student/Parent clicks on the ‘Change Values’ button to save changes.

6. System may respond with a message indicating that a credit card must be stored in order for auto-replenish to run.

7. Auto-replenish settings are stored.

8. If a credit card is required, auto-replenish will not run until this information is supplied.

Student/Parent Authorizes Automatic Fund Replenishment During Sign-Up:

1. Student/Parent selects ‘Credit Card’ as the payment method for the selected meal plan.

2. Student/Parent optionally chooses to store his/her credit card information and enters a secure ‘payment password.’

3. Prior to finalizing his/her account information, the customer chooses to save the credit card information for the account if not already saved (required for auto-replenish).

4. Student/Parent selects ‘Enable auto-replenish.’

5. Student/Parent enters the number of times auto-replenish should run.

6. Student/Parent selects how much should be added to the account every time auto-replenish is run against the account.

7. Student/Parent finalizes account information and auto-replenish settings are stored.

Student/Parent Adds Funds Via Mail.

1. Student/Parent fills out a deposit form (available via the web site), including account number.

2. If using a credit card, Student/Parent fills out credit card info and signs the deposit form.

3. Student/Parent mails deposit form and check to DS HQ.

Student/Parent Closes the Account Via Web Site.

1. Student/Parent logs in through the market site.

2. Student/Parent navigates to the Account section.

3. Student/Parent clicks on the Close Account link. (609)

4. If there exists an account balance, DS HQ disburses funds to the Student/Parent.

Student/Parent Reports a Lost Card Via Web Site.

1. Student/Parent logs in through the market site.

2. Student/Parent clicks on the “Lost Card” button. (610)

Student Checks Participating Restaurants in Their Market.

1. Student goes to the market site.

2. Student navigates to the Restaurants section and views the participating restaurants. (611)

Student/Parent Views Transaction History.

1. Student/Parent logs in through the market site.

2. Student/Parent navigates to the Balance & Transactions section.

3. Student/Parent clicks on “Transaction Report.” (612)

4. Student/Parent enters a range of dates and clicks on “Generate Report.” (613)

5. A report of all account transactions for the selected date range is displayed.

Student/Parent Resets Their Account Password.

1. Student/Parent navigates to their market site.

2. Student/Parent selects “Forgot Password” link. (614)

3. Student/Parent enters their email address on file with DS.

4. If the email address matches one on file, then the AWS generates a new password for the student and emails it to them.

Some of the above functions can also be performed in person or by telephone:

Student Adds Funds in Person.

1. Student brings check, cash, or credit card to campus office.

2. If using a credit card, the campus administrator enters the credit card info into the web system to process the transaction.

Student/Parent Closes the Account Via Phone.

1. Student/Parent calls the DS HQ or market office and requests that the account be closed.

2. If there exists an account balance, DS HQ disburses funds to the Student/Parent.

Student/Parent Closes the Account Via Mail.

1. Student/Parent mails a close account request to the DS HQ.

2. If there exists an account balance, DS HQ disburses funds to the Student/Parent.

Student Reports a Lost Card in Person.

1. Student goes to the market office and reports the lost card.

Student Reports a Lost Card Via Phone.

1. Student calls the DS HQ or market office and reports the lost card.

Public Web Server 202 (PWS) also provides a web interface 616 for the dining establishments (DE) 213-216 to check their accounts and view transaction histories, in a manner similar to the web interface for students and parents, and therefore not shown in further detail in this specification. In a preferred embodiment, PWS 202 enables the DEs 213-216 to perform additional functions, such as requesting fund transfers, obtaining franchising material and supplies, and ordering food items.

It can be seen from the foregoing description, that a versatile dining system may be implemented in accordance with this invention, in such a manner as to avoid the inconveniences of the prior systems. While this invention has been described in terms of a preferred embodiment, it should be understood that there can be variations, permutations, and equivalents of the preferred embodiment, which rightly fall within the general scope of this invention. For example, although this system has been described as having merchants (dining establishments) that provide only a dining business, it should be appreciated that this invention also may be carried out with merchants offering other goods and services. The identification means may take a wide range of allows a wide range of systems, including cards with magnetic stripes or other passive data storage means, smart cards, and the like. It is therefore intended that the appended claims be interpreted to include all systems that fall within the true spirit and scope of the present invention, and not be limited by the specific form of the preferred embodiments presented herein.

Appendix: Program Classes

Class Contact

Contains name and address information for a contact. Can be linked to any entity.

Properties

| | | |
|---|---|---|
| contactID | Int | Unique ID number of this contact |
| contactType | int | Describes the relationship between this contact and |
| | | its entity. (Manager, Owner, Parent, etc) |
| fname | string | First name |
| lname | string | Last name |
| address1 | string | First line of address |
| address2 | string | Second line of address |
| city | string | City |
| stateAbbr | string | 2 letter abbreviation of state |
| zip | string | Zip code |
| fax | string | Fax number |
| email | string | Email address |
| phone1 | string | Primary phone number |
| phone2 | string | Secondary phone number |

Methods

init(contactID)—sets the objects contact ID to the supplied argument, then calls init( ).

init( )—loads fields from the database.

create( )—creates a new database record for this contact.

update( )—updates an existing contact record in the database

delete( )—removes a contact record from the database

Class Market

Represents a market.

Properties

| | | |
|---|---|---|
| marketID | int | Unique ID of this market |
| districtID | int | ID of the District this Market belongs to |
| name | string | name of this Market |
| logo | string | Name of the logo file |
| darkColor | string | Dark color for web site |
| lightColor | string | Light color for web site |

Methods

init(campusID)—sets the objects campusID to the supplied argument, then calls init( ).

init( )—loads fields from the database.

create( )—creates a new database record for this campus.

update( )—updates an existing campus record in the database

delete( )—removes a campus record from the database

Class Campus

Represents a campus.

Properties

| | | |
|---|---|---|
| locationID | int | Unique ID of this location |
| physicalContact | Contact | Link to a Contact object the contains the |
| | | physical address of this campus |
| mailingContact | Contact | Link to a Contact object that contains the |
| | | mailing address of this campus |
| marketID | int | ID of the Market this campus belongs to |
| universityID | int | ID of the university this campus is linked |
| | | to (optional) |
| population | int | Population of the student body |
| logo | string | Name of the logo file |
| darkColor | string | Dark color for web site |
| lightColor | string | Light color for web site |

Methods

init(campusID)—sets the objects campusID to the supplied argument, then calls init( ).

init( )—loads fields from the database.

create( )—creates a new database record for this campus.

update( )—updates an existing campus record in the database

delete( )—removes a campus record from the database

Class University

Represents a University.

Properties

| | | |
|---|---|---|
| universityID | int | Unique ID of this University |
| name | string | Name of the University |
| mainContact | Contact | Link to Contact object of University's main |
| | | contact address |

Methods

init(universityID)—sets the objects universityID to the supplied argument, then calls init( ).

init( )—loads fields from the database.

create( )—creates a new database record for this university.

update( )—updates an existing university record in the database

delete( )—removes a university record from the database

Class ParentRestaurant

Represents a parent (chain) restaurant. Used to group members of a chain together.

Properties

| | | |
|---|---|---|
| parentID | int | Unique ID of this parent |
| name | string | Name |
| contact | Contact | Link to Contact object |

Methods

init(parentID)—sets the objects parentID to the supplied argument, then calls init( ).

init( )—loads fields from the database.

create( )—creates a new database record for this parent restaurant.

update( )—updates an existing parent restaurant record in the database

delete( )—removes a parent restaurant record from the database.

Class Restaurant

Represents a restaurant.

Properties

| | | |
|---|---|---|
| locationID | int | ID for this restaurant location |
| marketID | int | ID of the market this restaurant belongs |
| | | to |
| parentID | int | ID of this restaurants parent company |
| | | (optional) |
| name | string | Name of the restaurant |
| shortName | string | Short name of the restaurant |
| contractStart | Date | Date of the start of the current contract |
| contractEnd | Date | Date of the end of the current contract |
| eft | string | EFT routing number |
| notes | string | Notes |
| url | string | URL of the restaurant |
| logo | string | Path/filename of logo file |
| discountRate | DiscountRate[ ] | Array of DiscountRate objects for this |
| | | restaurant's contract |
| desc | string | Description |
| hours | string | Text field for listing the restaurant's |
| | | hours |
| statements | Statement[ ] | Array of statement objects for this |
| | | restaurant's statements |

Methods

init(locationID)—sets the objects locationID to the supplied argument, then calls init( ).

init( )—loads fields from the database.

create( )

update( )

delete( )

Class Statement

Represents a statement.

Properties

| | | |
|---|---|---|
| statementID | int | Unique ID of this statement |
| locationID | int | ID of restaurant this statement is for |
| startDate | Date | Start date of this statement |
| endDate | Date | End date of this statement |
| totalPaid | float | Total amount paid to restaurant for this statement |
| check | int | Number of check used to pay restaurant |

Methods

init(statementID)—sets the objects statementID to the supplied argument, then calls init( ).

init( )—loads fields from the database.

create( )—Create a new statement for the dates specified.

Class District

Represents a district.

Properties

| | | |
|---|---|---|
| districtID | int | Unique ID of this district |
| name | string | Name of the district |
| markets | Market[ ] | Array of Market objects that belong to this district |

Methods

init(districtID)—sets the objects districtID to the supplied argument, then calls init( ).

init( )—loads fields from the database.

create( )

update( )

delete( )

Class Region

Represents a region.

Properties

| | | |
|---|---|---|
| regionID | int | Unique ID of this region |
| name | string | Name of the region |
| districts | District[ ] | Array of District objects that belong to this region |

Methods

init(regionID)—sets the objects regionID to the supplied argument, then calls init( ).

init( )—loads fields from the database.

create( )

update( )

delete( )

Class Account

Represents a customer account.

Properties

| | | |
|---|---|---|
| accountID | int | Unique ID for this account |
| prefMail | Contact | Contact object representing the pre- |
| | | ferred mailing address for this account |
| curBalance | double | Current balance of this account |
| status | int | Flag to specify this account's current |
| | | status (Active/Inactive/Collections) |
| autoReplenishLeft | int | Number of remaining auto-replenish |
| | | cycles left |
| totalBonusBucks | double | Total number of Bonus Bucks granted |
| | | to this account |
| pin | string | PIN number |
| creditCard | CreditCard | CreditCard object linked to this account |

Methods

init(accountID)—sets the objects accountID to the supplied argument, then calls init( ).

init( )—loads fields from the database.

create( )

update( )

delete( )

createDeposit( )

createTransaction( )

Class CreditCard

Represents a customer's credit card.

Properties

| | | |
|---|---|---|
| accountID | int | Account that this Credit Card is linked to |
| cardName | string | Name on the card |
| cartType | int | Type of card (Visa, Mastercard, etc) |
| userCardNo | string | Card number encrypted by user's password |
| adminCardNo | string | Card number encrypted by admin password |
| cardExpMo | int | Month of expiration date |
| cadExpYr | int | Year of expiration date |

Methods

init(accountID)—sets the objects accountID to the supplied argument, then calls init( ).

init( )—loads fields from the database.

create( )

update( )

delete( )

getUserCardNo(privateKey)

getAdminCardNo(privateKey)

Class Entity

Basic entity class, designed to serve as a base class.

Properties

| | | |
|---|---|---|
| entityID | int | Unique ID of this entity |
| contact | Contact | Contact object for this entity |
| username | string | Username for this entity |
| passwd | string | Password hash for this entity |
| entityType | int | Type of this entity |
| ssn | string | SSN of this entity |

Methods

None

Class AdminUser Extends Entity

Represents an Administrator.

Properties

| | | |
|---|---|---|
| campuses | Campus[ ] | Array of campuses this admin is |
| | | responsible for |
| restaurants | Restaurant[ ] | Array of restaurants this admin is |
| | | responsible for |
| permissions | Permission[ ] | Array of permissions this admin has |
| navigation | Navigation[ ] | Array of Navigation elements this user has |
| | | access to |

Methods

init(entityID)—sets the objects entityID to the supplied argument, then calls init( ).

init( )—loads fields from the database.

create( )

update( )

delete( )

Class PublicUser Extends Entity

Represents a Public User.

Properties

| | | |
|---|---|---|
| primaryCampus | Campus | Campus object of user's primary campus |
| | | affiliation |
| account | Account | User's Account object |
| accountRole | int | Role of this user. |

Methods

init(entityID)—sets the objects entityID to the supplied argument, then calls init( ).

init( )—loads fields from the database create( )

update( )

delete( )

Class Deposit

Represents a deposit.

Properties

| | | |
|---|---|---|
| depositID | int | Unique ID of this deposit |
| accountID | int | Account deposit was made into |
| confirmed | int | Flag to indicate that money was received by HQ |
| checkNo | int | Check # (if applicable) of deposit |
| timestamp | Date | Timestamp of deposit |

Methods

init(depositID)—sets the objects depositID to the supplied argument, then calls init( ).

init( )—loads fields from the database create( )

confirm(checkNo)

Class Transacti ns

Represents a transaction.

Properties

| | | |
|---|---|---|
| transactionID | int | Unique ID of this transaction |
| accountID | int | Account ID of this transaction |
| locationID | int | Restaurant location ID |
| type | int | Type of transaction (normal/void/manual) |
| refNo | int | Reference number, used to reference |
| | | another transaction in the case of a void. |
| status | int | Status of this transaction (i.e. has it been |
| | | included in a statement and has the |
| | | restaurant been paid) |
| amount | double | Amount of this transaction |
| post_timestamp | Date | Date/Time this transaction was posted |
| swipe_timestamp | Date | Date/Time this transaction was approved |
| auth_no | int | Authorization number of this transaction |
| audit_entity_id_no | int | Entity ID of the entity that entered this |
| | | transaction if it was entered manually |
| applied_fl | int | Flag to indicate if this transaction has been |
| | | applied against the user's account. |

Methods

init(transactionID)—sets the objects transactionID to the supplied argument, then calls init( ).

init( )—loads fields from the database create( )

create( )

create(refNo)

void( )

Class Discount Rate

Represents a distinct discount rate.

Properties

| | | |
|---|---|---|
| lowerBound | int | Lower bound of the discount rate in sales dollars |
| upperBound | int | Upper bound of the discount rate in sales dollars |
| percent | int | Percent of sales that go to DS |

Methods

create( )

delete( )

Class DSCard

Represents a customer's credit card.

Properties

| | | |
|---|---|---|
| accountID | int | Account that this Credit Card is linked to |
| cardNo | string | Card number |
| active | boolean | Active flag |

Methods

init(cardNo)—sets the objects cardNo to the supplied argument, then calls init( ).

init( )—loads fields from the database.

create( )

update( )

Class ProcessTransactions

Contains methods to bring transactions in from the TPS servers and add them to the primary database. Applies these transactions to the account balances for each user.

Methods

processTransactions( )—Moves all transactions from the TPS databases to the web (main) database. Deletes these transactions from the TPS databases. Applies transactions to each user's account balance.

Class autoReplenish

Contains methods to add money via auto-replenish.

Methods

autoReplenish( )—Checks the balance for every account. For accounts that are below the minimum threshold, check the autoReplenish field. If this number is greater than 0, perform an auto-replenish via CC and decrement the autoReplenish field by one.

Having disclosed an exemplary embodiment and the best mode, I claim:

1. A dining system enabling customers to dine at any of a selected plurality of dining establishments in a greater-campus area, said dining system comprising:
a central accounting system, having:
a public web server, capable of interacting with said customers and said dining establishments over a public network;
an administrative web server capable of interacting with an administrator by secure communication means over a public network;
a plurality of transaction processing servers;
a database server, having an account for each of said customers and each of said dining establishments; said database server capable of communicating with said public web server, said administrative web server and said transaction processing servers;
Identification means unique to each customer for identifying a customer having an account in said database server;
a plurality of POS systems located within each of said dining establishments, and capable of communication with at least one of said transaction processing servers;
said POS systems including means, upon usage of said dining establishment by a customer, to input information relating to said customer and the amount of usage and to send commands to said transaction processing servers to debit money from the account of said customer and credit the account of said dining establishment;
means to reconcile the accounts of said dining establishments by debiting their accounts and sending them funds; and
web-based means for communicating with said public web server so that customers may review account information and transaction records, and may add additional funds to their account.

2. The dining system of claim 1, wherein said means to add additional funds includes automatic replenishment means to automatically increment said account by a predetermined amount when the account of said customer drops below a predetermined threshold.

3. The dining system of claim 1, wherein said said public web server includes promotional sales material and information about the dining establishments in said dining network.

4. The dining system of claim 1, wherein each of said transaction processing servers replicates at least in part the account information maintained in said database server; and said database server periodically polls each of said transaction processing servers to load transaction data.

5. The dining system of claim 1, wherein said public web server includes a standard access mode and a supervisory access mode for each account, and wherein said supervisory access mode enables control of the manner in which funds are disbursed from said account.

6. The dining system of claim 1, wherein said public web server includes a function to enable a customer to request a refund of at least a portion of the funds remaining in said customer's account.

7. The method for operating a dining system, said method comprising:
establishing a central accounting system, having:
a public web server, capable of interacting with customers over a public network;
an administrative web server capable of interacting with an administrator by secure communication means over a public network;
a plurality of transaction processing servers capable of interacting with selected dining establishments in a greater-campus area;
a database server, having an account for each of said customers and each of said dining establishments; said database server capable of communicating with said public web server, said administrative web server and said transaction processing servers;
entering account information for said customers and said dining establishments through said administrative web server;
receiving transaction information in at least one of said transaction processing servers;
debiting and crediting accounts in said database server as a result of said transaction information;
reconciling at least one account of said dining establishments by debiting said account and transferring money to said dining establishment; and
providing a web interface in said public web server so that customers may review their account, including transaction records, and add funds to their account.

8. The method of operating a dining system of claim 7, wherein said web interface enables customers to enter automatic replenishment information; said method including the additional step of automatically adding funds to a customer's account in accordance with said automatic replenishment information.

9. The method of operating a dining system of claim 7, wherein said web interface includes a standard access mode and a supervisory access mode for at least one account, and wherein said supervisory access mode enables control of the manner in which funds are disbursed from said account.

10. The method of operating a dining system of claim 7, wherein said web interface includes a function to enable a customer to request a refund of at least a portion of the funds remaining in said customer's account.

11. The method of operating a dining system of claim 7, including the additional step of maintaining a web interface containing promotional information about the dining establishments associated with said dining network.

12. The method of operating a dining system of claim 7, including the additional step of maintaining a web interface enabling each of said dining establishments to perform at least one of the following actions:
review their account;
request fund transfers; and
order supplies.
